(19) United States
(12) Patent Application Publication
(10) Pub. No.: US 2026/0212436 A1
(43) Pub. Date: Jul. 23, 2026

(54) AUTOMATED DIGITAL ACCOUNT INFORMATION CHANGE SYSTEMS AND METHODS

(71) Applicants: Allstate Insurance Company, Northbrook, IL (US); Allstate Northern Ireland Limited, Belfast (GB)

(72) Inventors: Philip Peter Ramirez, Northbrook, IL (US); Jhanani Dhakshnamoorthy, Northbrook, IL (US); Steven David, Northbrook, IL (US); Barbara Blye, Northbrook, IL (US); Christopher Tso, Northbrook, IL (US); Eamonn Hynes, Belfast, Northern Ireland (GB)

(21) Appl. No.: 18/960,371

(22) Filed: Jan. 21, 2025

(51) Int. Cl. G06Q 50/18

(52) U.S. Cl. CPC G06Q 50/186

(57) ABSTRACT

Systems and methods for automated digital account change are implemented. Execution of machine readable instructions by a processor causes the system to scan a digital footprint of digital accounts of a user, determine a detected event associated with the user that has occurred based on the detected event satisfying a trigger event condition, generate the interactive checklist including checklist action items to be performed to change information for at least one of the digital accounts of the user based on the detected event, automatically generate at least one prompt for at least one checklist action item of the checklist action items for the user to accept or reject the at least one checklist action item, modify the interactive checklist with an accept modification, and perform the at least one checklist action item to change information for at least one of the digital accounts of the user.

### TECHNICAL FIELD

The present disclosure relates to automated digital account information change systems and methods and, in particular, to systems and methods for automatically modifying an interactive checklist and performing a checklist action item included in the checklist based on a user response to one or more prompts.

### BACKGROUND

Major life events such as the death of a relative, a change in an employer, a move to a new city, and so forth, cause stress. As part of assisting individuals through these major life events and ensuring that they are able to make a smooth transition, companies may provide various services. For example, following a major life event such as a death of close relative, insurance companies may designate representatives that call individuals to provide counsel and assist in various estate planning matters. However, the assistance and counsel from these representatives may not be timely and comprehensive.

Accordingly, a need exists for providing individuals experiencing major life events with a comprehensive checklist of tasks that need to be completed to ensure that the stresses caused by such life events are reduced and these individuals are made aware of important tasks that need to be completed in a timely, efficient, and streamlined manner.

### BRIEF SUMMARY

According to the subject matter of the present disclosure, a method for automated digital account change implemented using a computing device, comprises: scanning a digital footprint of one or more digital accounts of a user associated with one or more digital platforms, determining, using an artificial intelligence neural network trained model, a detected event associated with the user has occurred based on the detected event satisfying at least one of a plurality of trigger event conditions, automatically generating, based on the detected event, an interactive checklist including a plurality of checklist action items to be performed to change information for at least one of the one or more digital accounts of the user based on the detected event, automatically generating at least one prompt for at least one checklist action item of the plurality of checklist action items on a display for the user to accept or reject the at least one checklist action item, automatically modifying the interactive checklist with an accept modification responsive to receiving user input for the at least one prompt via the display to accept the at least one checklist action item, and automatically performing the at least one checklist action item to change information for at least one of the one or more digital accounts of the user based on the detected event and based on the accept modification.

According to another embodiment, an intelligent system for automated digital account change, comprises: scan a digital footprint of one or more digital accounts of a user associated with one or more digital platforms, determining, using an artificial intelligence neural network trained model, a detected event associated with the user has occurred based on the detected event satisfying at least one of a plurality of trigger event conditions, automatically generate, based on the detected event, the interactive checklist including a plurality of checklist action items to be performed to change information for at least one of the one or more digital accounts of the user based on the detected event, automatically generate at least one prompt for at least one checklist action item of the plurality of checklist action items on a display for the user to accept or reject the at least one checklist action item, automatically modify the interactive checklist with an accept modification responsive to receiving user input for the at least one prompt via the display to accept the at least one checklist action item, and automatically perform the at least one checklist action item to change information for at least one of the one or more digital accounts of the user based on the detected event and based on the accept modification.

According to yet another embodiment, a system for automated digital account change, comprises: one or more processors, one or more memory components communicatively coupled to the one or more processors, and machine readable instructions stored in the one or more memory components that cause the intelligent system to perform at least the following when executed by the one or more processors: scan a digital footprint of one or more digital accounts of a user associated with one or more digital platforms, determining, using an artificial intelligence neural network trained model, a detected event associated with the user has occurred based on the detected event satisfying at least one of a plurality of trigger event conditions, the detected event comprises a death of the user, the death satisfying at least one of the plurality of trigger event conditions such as being verified as a legally reported death through a death reporting authority, automatically generate, based on the detected event, the interactive checklist including a plurality of checklist action items to be performed to change information for at least one of the one or more digital accounts of the user based on the detected event, automatically generate at least one prompt for at least one checklist action item of the plurality of checklist action items on a display for the user to accept or reject the at least one checklist action item, automatically modify the interactive checklist with an accept modification responsive to receiving user input for the at least one prompt via the display to accept the at least one checklist action item, the modifying including displaying the at least one prompt on the display of a user-device that is remote from and communicatively coupled to the one or more processors, and automatically perform the at least one checklist action item to change information for at least one of the one or more digital accounts of the user based on the detected event and based on the accept modification.

Although the concepts of the present disclosure are described herein with primary reference to an insurance solution, it is contemplated that the concepts will enjoy applicability to any setting for purposes of intelligent solutions, such as other business settings or otherwise.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a schematic view of an intelligent automated digital account change solution implemented by an intelligent system for automated digital account change, according to one or more embodiments described and illustrated herein;

FIG. 2A illustrates a flowchart for training and using the intelligent system, according to one or more embodiments described and illustrated herein;

FIG. 2B depicts a process of implementing the intelligent automated digital account change solution using the intelligent system, an artificial intelligence neural network trained model, and the various components of a server operating in conjunction, according to one or more embodiments shown and described herein;

FIG. 3 illustrates an embodiment of components within the server of the intelligent system of FIG. 1 that may be utilized to implement the intelligent automated digital account change solution as described herein, according to one or more embodiments shown and described herein;

FIG. 4A illustrates a server that operates to scan a digital footprint of a user, according to one or more embodiments shown and described herein;

FIG. 4B illustrates the server generating and outputting an interactive checklist on a user device of the user, according to one or more embodiments shown and described herein;

FIG. 4C depicts the user interacting with a plurality of checklist action items of the interactive checklist, according to one or more embodiments described and illustrated herein; and

FIG. 4D illustrates a mirror version of the modified interactive checklist accessible on the user device, according to one or more embodiments described and illustrated herein.

### DETAILED DESCRIPTION

In embodiments described herein and in greater detail below, an intelligent system for automated digital account change is configured to implement an intelligent digital account modification solution using one or more computing devices.

By way of example, and not as a limitation, the intelligent system may include a server scanning, using an artificial intelligence neural network trained model, a digital footprint of one or more digital accounts of a user associated with, as a non-limiting example, one or more digital platforms such as, e.g., FACEBOOK and LINKEDIN, digital content streaming services such as NETFLIX, AMAZON PRIME, HULU, and so forth, and websites of various credit card companies, utility companies, etc. After the digital footprint of a user is scanned, the server may determine that a detected event associated with the user has occurred, e.g., based on the detected event satisfying at least one of a plurality of trigger event conditions and generate an interactive checklist based on the detected event. The server, operating individually or in conjunction with various other servers, may enable output of the checklist, in real time, on a display of a device of the user. The server may also generate a prompt for at least one checklist action item of the plurality of checklist action items for output on a display for the user. The user may either accept or reject inclusion of the at least one checklist action item by accepting or rejecting the prompt. In response, the server may, in real time, perform the at least one checklist action item, as a result of which information for at least one of one or more digital accounts of the user may be changed.

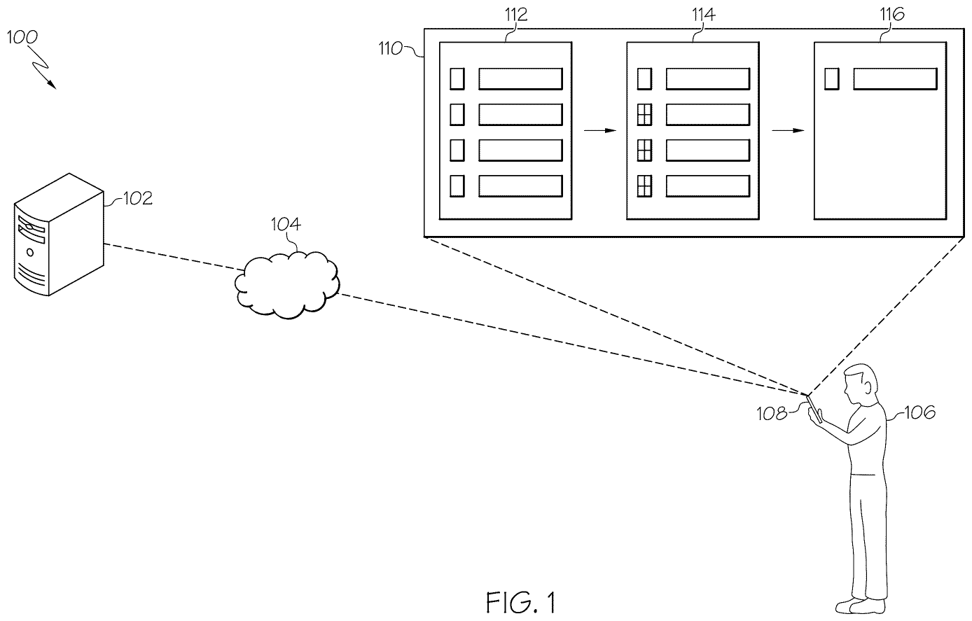

Referring to FIG. 1, an intelligent automated digital account change solution is shown, which may be implemented by an intelligent system 100 as described herein. It is noted that an implementation of the intelligent automated digital account change solution by the intelligent system 100 may include scanning automatically, by a server 102 communicatively coupled to a communication network 104, a digital footprint that is specific to a user 106, detecting an occurrence of an event based on data included in the digital footprint, and determining whether the detected event satisfies one or more of a plurality of trigger events conditions. The plurality of trigger events conditions may, as a non-limiting example, be associated with a name change of a user 106, an address change of the user 106, a job status of the user 106, a death of a user 106, a preparation of a will of the user 106, or combinations thereof. Upon determining that one or more trigger event conditions are satisfied, the server 102 may automatically generate, based on the detected event, an interactive checklist that includes a plurality of checklist action items to be performed. In embodiments, performing a checklist action may include changing information included in one or more digital accounts of the user 106.

In embodiments, the server 102 may, via the communication network 104, transmit instructions for displaying the generated interactive checklist on a display 110 of a user device 108 of the user 106. Upon receipt, the user device 108 may output the interactive checklist on the display 110 and enable the user 106 to modify the checklist, e.g., add or delete one or more checklist action items. In a first user interface 112 displayed on FIG. 1, an interactive checklist may include four checklist action items with respective user selectable checkboxes located adjacent to each checklist action item. A second user interface 114 depicts the user 106 selecting three out of the four checklist action items for deletion, and a third user interface 116 depicts a modified interactive checklist.

In embodiments, the server 102 may generate prompts for the inclusion of additional checklist action items to the checklist, which may appear on the display of a graphical user interface (GUI) of the user device 108 as user selectable icons. Based on the user 106 accepting or rejecting the displayed prompt, one or more action items may be included as part of the interactive checklist. Additionally, upon accepting and including a checklist action item as part of the interactive checklist, the server 102 may automatically perform one or more actions based on the at least one checklist action item, e.g., change information for at least one of the one or more digital accounts of the user based on the detected event and based on the accept modification.

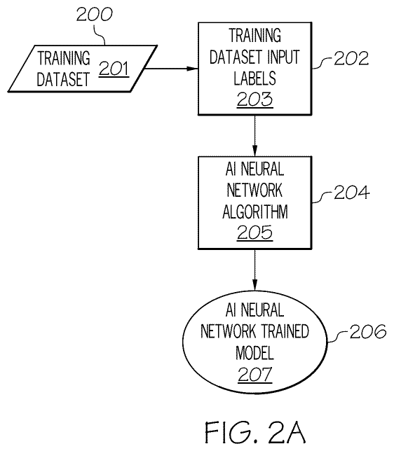

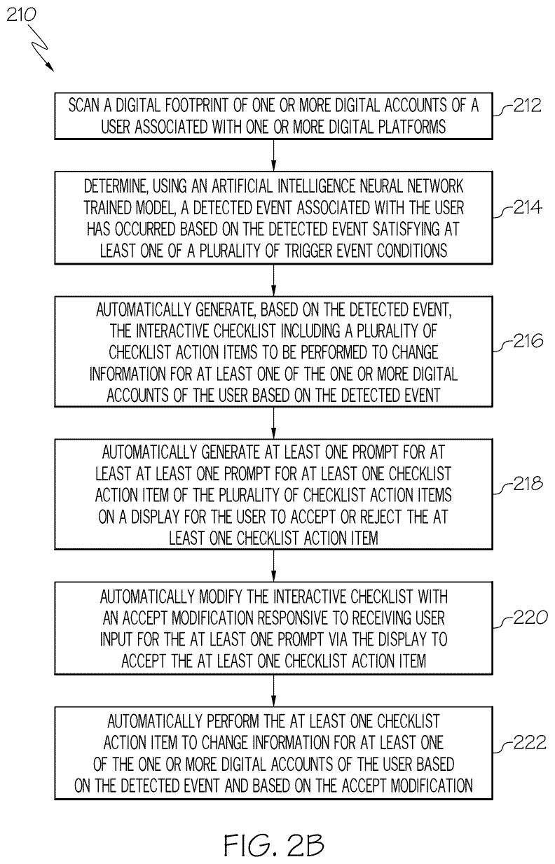

FIG. 2A illustrates a flowchart for training and using the intelligent system 100. The flowchart includes a block 200 in which a training dataset 201 is trained, and a block 202 in which one or more training dataset input labels 203 are included. In block 204, an artificial intelligence neural network algorithm 205 is trained via blocks 200 and 202 and associated training dataset 201 and training dataset input labels 203 and applied via an artificial intelligence neural network trained model 207 of block 206. The training may involve utilizing inputs in the form of data associated with, as a non-limiting example, a plurality of user interactions with various digital platforms such as, LINKEDIN, FACEBOOK, etc., digital content streaming services such as, e.g., NETFLIX, AMAZON PRIME, etc., and websites associated with various credit card companies, utility companies, and so forth, to determine whether one or more of a plurality trigger event conditions are satisfied. In embodiments, the artificial intelligence neural network trained model 207 of block 206 may be further trained such as through machine learning, allowing for at least partially automated training using the artificial intelligence neural network algorithm 205 of block 204. The artificial intelligence neural network trained model 207 may be implemented as part of the intelligent system 100 as described herein to generate an interactive checklist based on determining that a trigger event has been satisfied. The artificial intelligence neural network trained model implemented as part of the intelligent system 100 may also be utilized to modify, in real time, the generated interactive checklist based on input from the user 106, in addition to automatically performing one or more checklist action items included on the interactive checklist such as, e.g., changing information for at least one of the one or more digital accounts of the user based on the detected event and based on a modification accepted by the user 106 (e.g., the user 106 accepting a prompt generated by the server 102).

The artificial intelligence neural network trained model 207 may utilize the artificial intelligence neural network algorithm 205 to generate further training dataset input labels 203 associated with the training dataset 201, such as through machine learning. In embodiments, the training dataset 201 may include data in the form text messages and other types of digital content that may be representative of the interactions of the user 106 with various digital platforms. The digital content may also include images, videos, and so forth, that are posted on various social media platforms and the text messages may be those posted on the social media profile of the user 106. Dates and times at which the digital content was captured, messages were posted, and so forth, may also be included as part of the training dataset 201.

All or parts of the training dataset may be raw data in the form of images, text, files, videos, and so forth, that may be processed and organized. Such processing and organization may include adding training dataset input labels 203 to the raw data so that the artificial intelligence neural network trained model 207 may be trained based on the training dataset 201, the training dataset input labels 203, and the artificial intelligence neural network algorithm 205, to efficiently generate various results with an aim to be within a certain accuracy percentage and may be associated with confidence threshold values. Such results may be utilized, as described herein, to determine whether one or more detected events, based on analyzing the data associated with the user interactions, satisfies one or more of a plurality of trigger event conditions.

One or more artificial neural networks (ANNs) used for the artificial intelligence neural network trained model 207 and the artificial intelligence neural network algorithm 205 may include connections between nodes that form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling.

The intelligent system 100 described herein may utilize one or more ANN models as understood to those skilled in the art or as yet-to-be-developed to generate results as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

In embodiments, a convolutional neural network (CNN) may be utilized. For example, a convolutional neural network (CNN) may be used as an ANN that, in a field of machine learning, for example, is a class of deep, feed-forward ANNs that may be applied for audio-visual analysis. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture.

FIG. 2B depicts a process 210 of implementing the intelligent automated digital account change solution using the intelligent system 100, the artificial intelligence neural network trained model 207, and various components of the server 102 and the user device 108, operating in conjunction.

In block 212, a digital footprint of one or more digital accounts of the user 106 associated with one or more digital platforms may be scanned. For example, the digital footprint specific to the user 106 may pertain to data regarding a plurality of user interactions associated with various digital platforms, e.g., social media platforms such as LINKEDIN, FACEBOOK, etc. The digital footprint may also include, as a non-limiting example, data associated with user interactions and/or accounts with various websites, e.g., websites of credit card companies visited by the user 106 in order to pay credit card bills, websites of utility companies with which the user has associated accounts, digital content streaming companies such as NETFLIX, AMAZON PRIME, and so forth. The digital footprint may also include data of various email accounts of the user 106. In embodiments, the server 102 may only be able to access data associated these user interactions upon receiving prior authorization from the user 106 in real time. Additionally, in embodiments, the server 102 may be able to access digital footprints of other users, e.g., relatives of the user 106, etc., and share the digital footprints of these relatives with the user 106 upon being provided the appropriate authorizations from the relatives, third party providers, and other pertinent parties. In embodiments, the data from these websites and digital platforms may be obtained and collated on a daily basis, a weekly basis, or based on a customized time frame.

In block 214, using an artificial intelligence neural network trained model 207, a detected event associated with the user 106 that has occurred based on the detected event satisfying at least one of a plurality of trigger event conditions may be determined. In embodiments, upon accessing a digital footprint specific to the user 106, the server 102 may analyze data of text, images, and various digital content included as part of the digital footprint within predefined time frames, and possibly identify the occurrence of various events. Data indicating the possible occurrence of these events may be compared to one or more of a plurality of trigger event conditions, and if any the plurality of trigger event conditions are satisfied, one or more of these events may be classified, by the server 102 as a detected event.

In embodiments, the plurality of trigger event conditions may be, e.g., a name change of the user 106, an address change of the user 106, a change in a job status of the user 106, a death of the user 106, a request for the preparation of or the preparation of a will for the user 106, or combinations thereof. Other examples of trigger event conditions may include the activation or deactivation of a digital content streaming service subscription such as NETFLIX, AMAZON PRIME, HULU, and so forth, or email correspondences that include, as a non-limiting example, key phrases such as, e.g., “prepare a will,” “estate planning,” “untimely death or demise,” etc. Other examples may include a message posted on a social media platform associated with the user 106 such a LINKEDIN or FACEBOOK account of the user 106. Keywords in the posted message may be analyzed by the server 102 and compared to one or more of the plurality of trigger event conditions. In this way, the server 102 may determine, using the artificial intelligence neural network trained model 207, that a detected event associated with the user 106 has occurred based on the detected event satisfying at least one of a plurality of trigger event conditions.

In block 216, based on the detected event, the interactive checklist including a plurality of checklist action items to be performed to change information for at least one of the one or more digital accounts of the user may be automatically generated. For example, the server 102 may analyze the text of messages posted on the Facebook profile page of the user 106. These messages may indicate that the user 106 has changed his employer, altered the title of his current position at a company (e.g., reflecting a promotion from “associate” to “partner”, “associate” to “director”, etc.), and/or indicated that he or she will be moving to new city. The server 102 may, upon analyzing such text, generate an interactive checklist that includes a plurality of checklist action items. For example, if the server 102 determines that the detected event corresponds to moving to a new city, the server 102 may generate an interactive checklist that includes a variety of tasks that need to be completed in relation to the move of the user 106 to the new city. For example, a set of checklist action items may include informing various utility companies that gas, water, electricity, and so forth, need to be turned off prior to or by a particular date. Another set of checklist action items may include confirming that the current residential lease has terminated correctly and a new residential lease in a new city has been signed, informing your car insurance company of a move to a new city (e.g., in a different state), contacting a moving company, and so forth.

In block 218, at least one prompt for at least one checklist action item of the plurality of checklist actions items may be automatically generated on the display 110 for the user to accept or reject the at least one checklist action item. In embodiments, the server 102 may determine that a particular checklist action item may need to be added as part of the interactive checklist, but prior to the addition, the server 102 may transmit a request for approval from the user 106 to contact the user's credit card company and, e.g., access address information of the user 106 and other such personal identification or confidential information that may be stored in the servers of the credit card company. In embodiments, the request for approval may be displayed on the display 110 of the user device 108 in the form of a prompt. Upon receiving authorization from the user 106 (e.g., selection of an accept modification action based on selection of an interactive icon), the server 102 may include, in real time, the checklist action item as part of the interactive checklist. The checklist action item may be associated with updating a current address stored with a credit card company.

In block 220, the interactive checklist may be automatically modified responsive with an accept modification responsive to receiving user input for the at least one prompt via the display to accept the at least one checklist action item. In embodiments, prior to the addition of the checklist action item associated with updating the current address is added to the checklist, another prompt may be displayed on the display of the user device 108 that may include user selective icons labeled “add to list” or “do not add to list”. The user 106 may select “add to list” to add the new checklist action item to the interactive checklist or select “do not add to list” to prevent inclusion of the checklist action item to the interactive checklist. In this way, the server 102 may enable, in real time, a modification of the interactive checklist. Another checklist action item that the server 102 may recommend to be included as part of the interactive checklist may include, e.g., changing a billing address with a gas company and terminating current services with the gas company. A prompt that is specific to including such a checklist action item may be displayed on the display of the user device 108, which the user 106 may accept or reject.

In block 222, the at least one checklist action item may be automatically performed to change information for at least one of the one or more digital accounts of the user based on the detected event and based on the accept modification. In embodiments, if the user 106 accepts inclusion of the checklist action items for updating the current address associated with the credit card company and terminate current services with a gas company, the server 102 may automatically perform both of these checklist action items within a time frame. For example, upon the user 106 accepting inclusion of both of these action items as part of the interactive checklist, the server 102 may, in real time, update the current address associated with the credit card company to a new address in a new city and terminate services with a gas company.

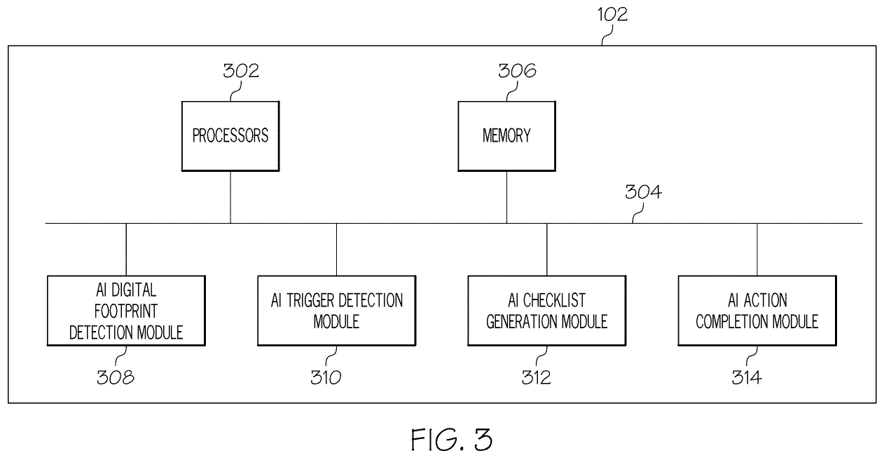

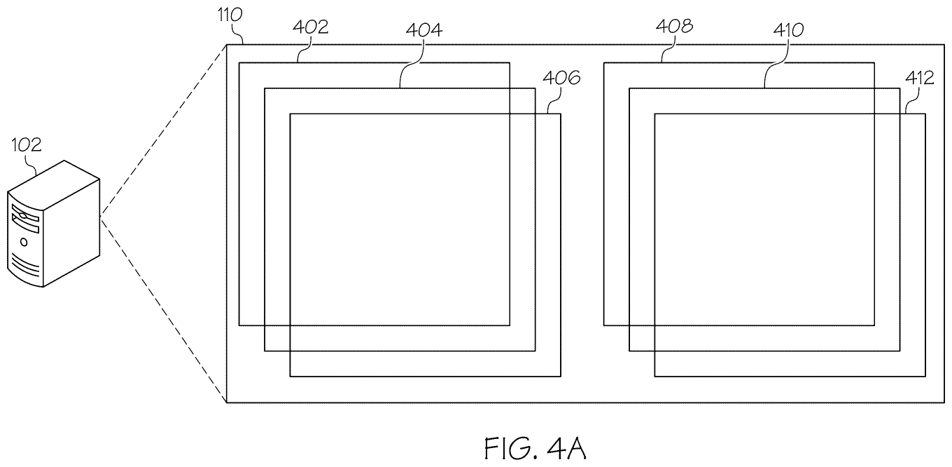

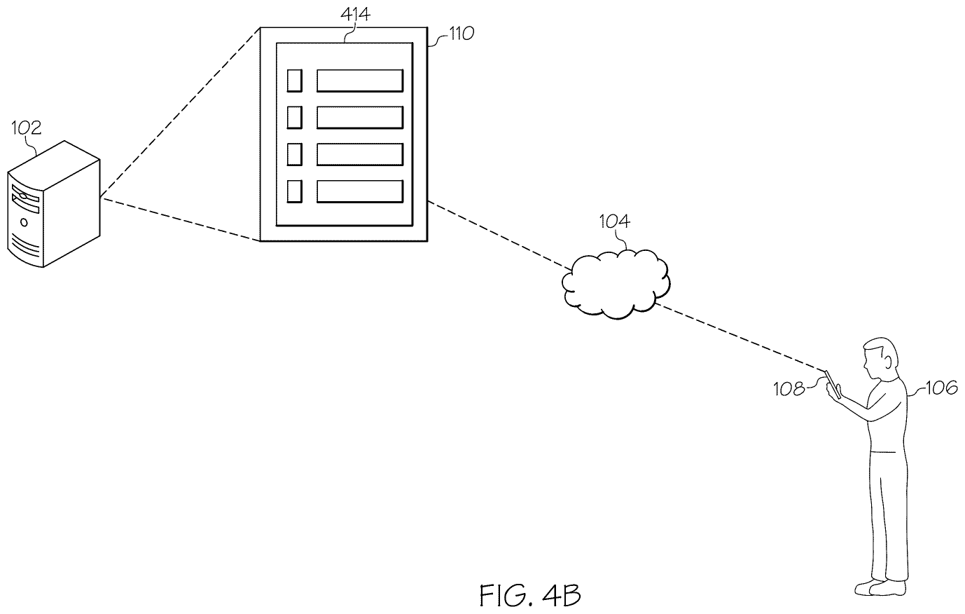

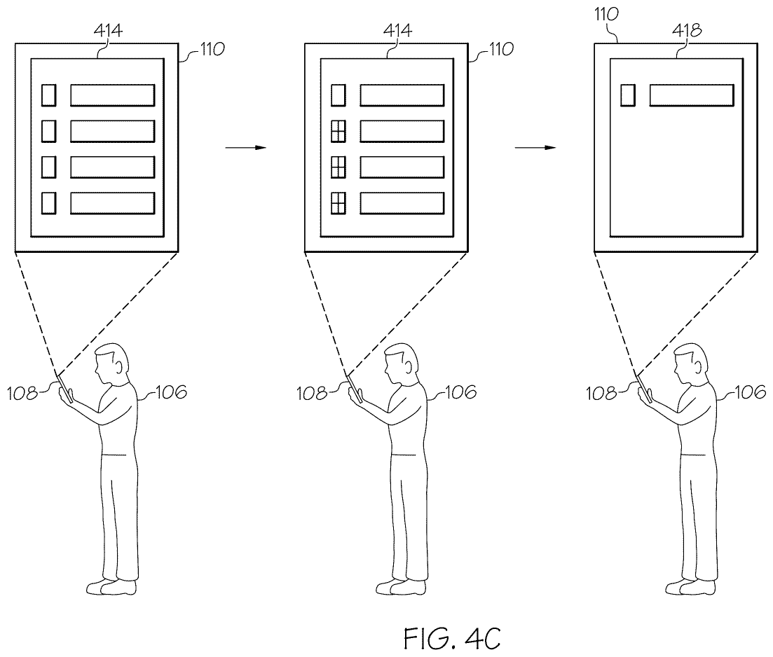

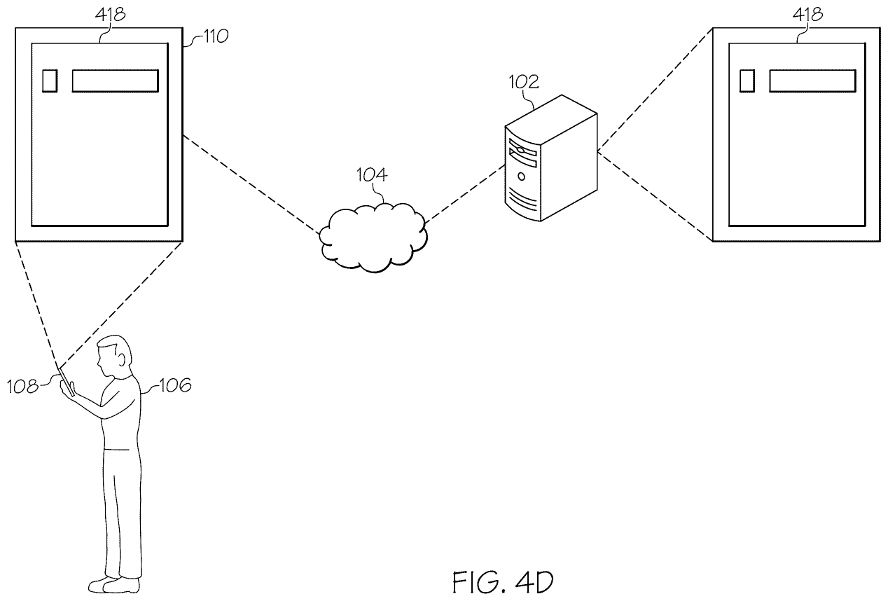

FIG. 3 illustrates a server 102, utilized to implement the intelligent system 100, that includes one or more processors 302, a communication path 304 that communicatively couples all of the components within the server 102, a memory 306, an artificial intelligence based digital footprint detection module 308, an artificial intelligence based trigger detection module 310, an artificial intelligence based checklist generation module 312, and an artificial intelligence based action completion module 314 for use with the process flows described herein, such as the process described in FIG. 2B above, and with embodiments of operations of the intelligent system 100, such as illustrated in FIGS. 4A-4D , also described in greater detail below.

FIG. 3 illustrates an embodiment of components within the server 102 of the intelligent system 100 of FIG. 1 that may be utilized to implement the intelligent automated digital account change solution as described herein. While the server 102 is shown as a single computing device, it is contemplated that a plurality of computing devices across the communication network 104 may serve as the server 102. The server 102 may be installed as part of a hardware component that is communicatively coupled to the user device 108 via the communication network 104. The server 102 may be configured to, based on manual input or automatically and without user intervention, scan a digital footprint of the user 106, determine whether an event, based on analyzing data associated with the digital footprint, satisfies at least one of a plurality of trigger event conditions, generate an interactive checklist based on the detected event, generate a prompt for at least one checklist action item included as part of the interactive checklist, automatically modify the interactive checklist based on input from the user 106, and perform at least one checklist action item based on the input.

The user device 108 illustrated in FIG. 1 may be a computing device such as a smartphone, a laptop, or other such devices. The interactive checklist generated by the server 102 may be transmitted to the user device 108 via the communication network 104 and output on the display 110 of the user device 108. In embodiments, the user 106 may modify the interactive checklist by selecting one or more interactive icons included as part of the interactive checklist. Additionally, the user 106 may accept or reject various prompts output on the display 110 of the user device 106, as a result of which, the server 102 may automatically perform various tasks associated with one or more checklist action items such as, e.g., delete existing checklist action items, add new checklist action items to the interactive checklist, and so forth. As used herein, the term “communicatively coupled” means that the coupled components are capable of exchanging data signals with one another such as, for example, electrical signals via conductive medium, electromagnetic signals via air, optical signals via optical waveguides, and the like. The one or more processors 302 may be configured to operate in a distributed computing environment, and may communicate with one or more external devices as part of a wide area network (WAN), such as an intranet, internet, and so forth.

The memory 306 may comprise RAM, ROM, flash memories, hard drives, or any device capable of storing machine readable and executable instructions such that the machine readable and executable instructions can be accessed by the one or more processors 302. The machine readable and executable instructions may comprise logic or algorithm(s) written in any programming language of any generation (e.g., 1GL, 2GL, 3GL, 4GL, or 5GL) such as, for example, machine language that may be directly executed by the one or more processors 302 or assembly language, object-oriented programming (OOP), scripting languages, microcode, etc., that may be compiled or assembled into machine readable and executable instructions and stored on the memory 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the memory 306 stores various types of data, e.g., the data included in the training dataset 201 and the training dataset input labels 203, via a communicatively coupled storage feature such as a database. The memory 306 may store user interaction data associated with various users, interactive checklists that are generated based on the satisfaction of various trigger event conditions, modified interactive checklists, and so forth.

The artificial intelligence (AI) based digital footprint detection module 308, operating in conjunction with one or more processors 302, may scan various digital platforms with which the user 106 interacts, obtain and collate user interaction data, and generate a footprint based on the collected interaction data. The artificial intelligence based trigger detection module 310 may determine, based on analyzing the user interaction data, whether any events detected from the data satisfy one or more of a plurality of trigger event conditions. Based on the satisfaction of one or more trigger event conditions, one or more interactive checklists may be generated by the artificial intelligence based checklist generation module 312. Additionally, based on the response to one or more prompts by the user 106, one or more of the checklist action items included in the interactive checklist may be performed by the artificial intelligence based action completion module 314.

FIG. 4A illustrates a server 102 scanning a digital footprint of the user 106. In embodiments, a digital footprint specific to the user 106 may be scanned and analyzed, and data specific to the user 106 may be accessed and stored in memory 306 of the server 102. For example, the server 102 may access, collate, and analyze data associated with interactions of the user 106 with digital sources 402, 404, 406, 408, 410, and 412. These digital sources 402, 404, 406, 408, 410, and 412 may be various email accounts associated with the user 106, various websites visited by the user 106 such as, e.g., websites of the user's credit card company, utility company, federal, state, and local government websites, and so forth. The digital sources 402, 404, 406, 408, 410, and 412 may also include various social media platforms visited by the user 106 over a predefined time frame. In embodiments, the server 102 may access data specific to a user at predefined intervals such as, e.g., between 10:00 AM and 12:00 PM every day, at 11:00 PM on a single day of the week, and so forth.

In embodiments, after data accessed from the digital sources 402, 404, 406, 408, 410, and 412 is accessed and collated, the server 102 may analyze the data in order to determine whether an event associated with the user 106 has occurred. The server 102 may compare data associated with text, images, and digital content with a plurality of trigger event conditions. The trigger event conditions may be designated as, e.g., a name change, an address change, a job status, a death of the user 106, data related to the preparation of a will by the user 106, and so forth. For example, the server 102 may analyze data obtained from the digital sources 402, 404, 406, 408, 410, and 412 and identify text in the form of a message posted by the user 106 on a social media platform (e.g., FACEBOOK profile) on a particular date stating that the user 106 will be moving to a new city. The server 102 may also identify text in the form of another message posted by the user's Facebook profile indicating that the user 106 has started a new position at a different company.

In another example, the server 102 may analyze text in emails sent and received via a user's email account and determine that the user 106 has communicated a request to an attorney to draft a Will. In yet another example, the server 102 may identify and analyze a message posted on the user's timeline indicating that the user or a close family member has passed away, in addition to various condolence messages in relation to the posted message, and determine that a relative of the user and/or his or her relative may have passed away. The server 102 may determine that user's posted messages indicating a move to a new city, a death of a relative, a new position at a different company, etc., are all messages that satisfy different trigger event conditions. In embodiments, an address change trigger event condition may also be satisfied if the server 102 detects an address change notification email that the user may have received from a postal service subscription. In embodiments, a trigger event condition of a death of a user or his or her relative may be satisfied if the server 102 verifies data indicating that a death certificate was received in an email account of the user 106 or the relative, if the death of the user 106 or a relative is legally reported through a death reporting authority, and so forth. Other such examples of trigger events conditions are also contemplated.

FIG. 4B illustrates the server 102 generating and outputting an interactive checklist on a user device 108 of the user 106. In embodiments, the server 102, upon determining that a trigger event condition has been satisfied, may generate an interactive checklist 414 that is specific to the satisfied trigger event condition and transmit instructions for and facilitate display of the interactive checklist 414 on the display 100 of the user device 108. For example, if the satisfied trigger event condition relates to a death of a relative of the user, the interactive checklist 414 may include a plurality of checklist action items that need to be performed in order to ensure, e.g., that the estate of the deceased is managed properly. The checklist action items may include, e.g., informing trustees, accounts, attorneys, and other professionals of the occurrence of the death of the relative so that the estate management process is initiated. Other action items may include a recommendation to obtain information about bank accounts, 401k plans, etc. of the relative, and various subscriptions of the relative that the relative may have purchased and respective fees being paid for these subscriptions. Additionally, other action items may include instructions for closing one or more digital accounts of the deceased relative, e.g., subscriptions for various services such as internet, cable, NETFLIX, AMAZON PRIME, and so forth.

In embodiments, the server 102 may, upon determining that one or more trigger event conditions are satisfied, further determine that access to confidential information associated with the deceased relative may need to be accessed. For example, the server 102 may determine that, in order to generate an additional action item related to, e.g., a personal bank account of the deceased relative, the server 102 may need authorization from an individual that is next of kin, whom may be the user 106. As such, in embodiments, the server 102 may send an authorization request, in real time, to the user device 108 of the user 106, which may be output in the form of a prompt on the display 110 of the user 106 in real time. The user 106 may, in response, select a option displayed on the prompt to provide the authorization for the server 102 to access the confidential financial information of the relative.

In embodiments, additional authorization requests may be transmitted by the server 102 in order to perform other actions with respect to the checklist action items. In embodiments, the server 102 may transmit authorization requests regarding whether the user 106 would like a particular action item to be included as part of the interactive checklist 414. Upon receiving authorization to include the action item, the server 102 may add the action item to the interactive checklist 414 in real time. For example, the server 102 may determine that an action item for renewing a shared streaming account between the relative and user 106 may need to be included as part of interactive checklist 414, and as such, may transmit an authorization request that may be displayed in the form of a prompt on the display of the user device 108. The user 106 may, however, already receive emails in the form of updates regarding his personal streaming subscription, and as such, the user 106 may deny the request to include the action item regarding the shared streaming account as part of the interactive checklist 414. In another example, the server 102 may determine than an action item for disabling another streaming account of the deceased relative and another action item for paying overdue credit card fees may need to be included as part of the interactive checklist 414, and as such, may transmit respective authorization requests for including these action items on the checklist. The user 106 may provide his authorization in response to which both of these action items may be included, in real time, as part of the interactive checklist 414.

FIG. 4C depicts the user 106 interacting with a plurality of checklist action items included as part of the interactive checklist 414. In embodiments, the interactive checklist 414 may include a plurality of action items that are pertinent to several tasks that need to be performed after detection of a trigger event condition, e.g., the death of a relative. These action items may include closing or disabling a plurality of digital accounts, e.g., streaming accounts such as AMAZON PRIME or NETFLIX, various bank accounts and so forth. Other action items may include a recommendation to schedule an appointment with one or more professionals and organizations such as, e.g., an estate attorney, an account, and an organization that handles funeral arrangements, and so forth. Each of these actions items may be displayed on the display 400 in the form of a list on the interactive checklist 414. In embodiments, each action item on the interactive checklist 414 may have a respective selectable checkbox adjacent to it.

In embodiments, the user 106 may determine that multiple action items on the interactive checklist 414 may be redundant or may have already been performed, and as such, the user 106 may select checkboxes adjacent to three out of four action items, and modify the interactive checklist 414, e.g., by removing these action items from the list. In embodiments, in response to the selection of the action checkboxes adjacent to the action items and an additional selection of, e.g., a “delete” or “remove” icon on the display 400 (not shown), the server 102 may modify the interactive checklist 414, in real time. The server 102 may transmit instructions via the communication network 104 to the user device 108 for deleting three out of the four action items. In this way, the server 102, based on input from the user 106, may generate a modified interactive checklist 418. While modification in the form of deleting actions items from the interactive checklist 414 is illustrated in FIG. 4C, other types of modifications are also contemplated. For example, new action items may be included as part of the interactive checklist 414, language in the existing action items may be edited, and so forth.

FIG. 4D illustrates a mirror version of the modified interactive checklist 418 accessible on the user device 106 that is generated by the server 102. In embodiments, the server 102 may, based on receiving input from the user 106 relative to the interactive checklist 414 output on the display, transmit instructions for modifying the interactive checklist 414 to generated a modified interactive checklist 418 while simultaneously generating a substantially identical version of the modified interactive checklist 418 and store the modified interactive checklist 418 in memory 306 associated with the server 102. In other embodiments, after receipt of instructions from the server 102 and generating the modified interactive checklist 418 (displayed on the display of the user device 108), the user device 108 may transmit the modified interactive checklist 418 to the server 102. In this way, the server 102 may have access to the latest version of action items that need to be completed, namely, e.g., the single action item in the modified interactive checklist 418. In embodiments, upon generation of the modified interactive checklist 418, the server 102 may automatically initiate a process to complete or perform one or more tasks based on the single action item in the modified interactive checklist 418.

For example, if the single action item on the modified interactive checklist 418 is associated with closure of one or more digital accounts of the relative of the user 106, e.g., the closure or deactivation of a streaming account or other account, and so forth, the server 102 may automatically contact the streaming account service providers or other account vendors and request such a deactivation. It is also noted that recitations herein of “at least one” component, element, etc., should not be used to create an inference that the alternative use of the articles “a” or “an” should be limited to a single component, element, etc. It is noted that recitations herein of a component of the present disclosure being “configured” or “programmed” in a particular way, to embody a particular property, or to function in a particular manner, are structural recitations, as opposed to recitations of intended use.

It is also noted that recitations herein of “at least one” component, element, etc., should not be used to create an inference that the alternative use of the articles “a” or “an” should be limited to a single component, element, etc. It is noted that recitations herein of a component of the present disclosure being “configured” or “programmed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### Aspects Listing

Aspect 1. A method for automated digital account change implemented using a computing device, comprising scanning a digital footprint of one or more digital accounts of a user associated with one or more digital platforms, determining, using an artificial intelligence neural network trained model, a detected event associated with the user has occurred based on the detected event satisfying at least one of a plurality of trigger event conditions, automatically generating, based on the detected event, an interactive checklist including a plurality of checklist action items to be performed to change information for at least one of the one or more digital accounts of the user based on the detected event, automatically generating at least one prompt for at least one checklist action item of the plurality of checklist action items on a display for the user to accept or reject the at least one checklist action item, automatically modifying the interactive checklist with an accept modification responsive to receiving user input for the at least one prompt via the display to accept the at least one checklist action item, and automatically performing the at least one checklist action item to change information for at least one of the one or more digital accounts of the user based on the detected event and based on the accept modification.

Aspect 2. The method of Aspect 1, wherein automatically modifying the interactive checklist further comprises displaying the at least one prompt on the display of a user-device that is remote from and communicatively coupled to the computing device.

Aspect 3. The method of Aspect 2, further comprising adding a checklist action item to the plurality of checklist action items as part of the interactive checklist based on a response to the at least one prompt.

Aspect 4. The method of Aspect 2, further comprising removing the at least one checklist action item responsive to receiving user input for the at least one prompt via the display to reject the at least one checklist action item.

Aspect 5. The method of any of Aspect 1 to Aspect 4, wherein the detected event comprises a name change of the user, the name change satisfying at least one of the plurality of trigger event conditions such as being verified as a legal name change.

Aspect 6. The method of any of Aspect 1 to Aspect 5, wherein the detected event comprises an address change of the user, the address change satisfying at least one of the plurality of trigger event conditions such as a notification of the address change via a postal service subscription.

Aspect 7. The method of any of Aspect 1 to Aspect 6, wherein the detected event comprises one or more of a name change of the user, an address change of the user, a job status of the user, a death of the user, a will preparation for the user, or combinations thereof.

Aspect 8. A method of any of Aspect 1 to Aspect 7, wherein the detected event comprises a death of the user, the death satisfying at least one of the plurality of trigger event conditions such as being verified as a legally reported death through a death reporting authority.

Aspect 9. The method of Aspect 8, wherein the interactive checklist comprises the plurality of checklist action items to be performed by another user in response to the death of the user, the plurality of action items including closure of the one or more digital accounts of the user.

Aspect 10. An intelligent system for automated digital account change comprising one or more processors, one or more memory components communicatively coupled to the one or more processors, and machine readable instructions stored in the one or more memory components that cause the intelligent system to perform at least the following when executed by the one or more processors: scan a digital footprint of one or more digital accounts of a user associated with one or more digital platforms, determine, using an artificial intelligence neural network trained model, a detected event associated with the user has occurred based on the detected event satisfying at least one of a plurality of trigger event conditions, automatically generate, based on the detected event, the interactive checklist including a plurality of checklist action items to be performed to change information for at least one of the one or more digital accounts of the user based on the detected event, automatically generate at least one prompt for at least one checklist action item of the plurality of checklist action items on a display for the user to accept or reject the at least one checklist action item, automatically modify the interactive checklist with an accept modification responsive to receiving user input for the at least one prompt via the display to accept the at least one checklist action item, and automatically perform the at least one checklist action item to change information for at least one of the one or more digital accounts of the user based on the detected event and based on the accept modification.

Aspect 11. The intelligent system of Aspect 10, wherein the machine readable instructions causing the intelligent system to automatically modify the interactive checklist when executed by the one or more processors includes: displaying the at least one prompt on the display of a user-device that is remote from and communicatively coupled to the one or more processors.

Aspect 12. The intelligent system of Aspect 11, wherein the machine readable instructions further cause the intelligent system to perform at least the following when executed by the one or more processors: add a checklist action item to the plurality of checklist action items as part of the interactive checklist based on a response to the at least one prompt.

Aspect 13. The intelligent system of Aspect 11, wherein the machine readable instructions further cause the intelligent system to perform at least the following when executed by the one or more processors: remove the at least one checklist action item responsive to receiving user input for the at least one prompt via the display to reject the at least one checklist action item.

Aspect 14. The intelligent system of any of Aspect 10 to Aspect 13, wherein the detected event comprises a name change of the user, the name change satisfying at least one of the plurality of trigger event conditions such as being verified as a legal name change.

Aspect 15. The intelligent system of any of Aspect 10 to Aspect 14, wherein the detected event comprises an address change of the user, the address change satisfying at least one of the plurality of trigger event conditions such as a notification of the address change via a postal service subscription.

Aspect 16. The intelligent system of any of Aspect 10 to Aspect 15, wherein the detected event comprises one or more of a name change of the user, an address change of the user, a job status of the user, a death of the user, a will preparation for the user, or combinations thereof.

Aspect 17. The intelligent system of any of Aspect 10 to Aspect 16, wherein the detected event comprises a death of the user, the death satisfying at least one of the plurality of trigger event conditions such as being verified as a legally reported death through a death reporting authority.

Aspect 18. The intelligent system of Aspect 17, wherein the interactive checklist comprises the plurality of checklist action items to be performed by another user in response to the death of the user, the plurality of action items including closure of the one or more digital accounts of the user.

Aspect 19. An intelligent system for determining digital image duplication for anonymized digital images comprising: one or more processors; one or more memory components communicatively coupled to the one or more processors; and machine readable instructions stored in the one or more memory components that cause the intelligent system to perform at least the following when executed by the one or more processors: receive an upload of a digital image by an artificial intelligence based software application, generate, using the artificial intelligence based software application, an encoding of the digital image, compare the encoding of the digital image with a first stored encoding of a plurality of stored encodings corresponding to a first anonymized digital image of the plurality of anonymized digital images to generate a first comparison, determine a first similarity metric based on the first comparison, compare the first similarity metric to a threshold, determine, using the artificial intelligence based software application, that the digital image is sufficiently duplicative of the first anonymized digital image of the plurality of anonymized digital images associated with the first stored encoding when the first similarity metric equals or exceeds the threshold, transmit a message indicating an identification of the digital image as sufficiently duplicative of the first anonymized digital image of the plurality of anonymized digital images, output the message on a display of an external device communicatively coupled to and remote from the computing device, and transmit a request for the first anonymized digital image to a platform on which the first anonymized digital image is stored based on the identification of the digital image as sufficiently duplicative of the first anonymized digital image.

Aspect 20. The intelligent system of Aspect 19, wherein the message includes text indicating a likelihood of insurance fraud associated with the digital image.

What is claimed is:

1. A method for automated digital account change implemented using a computing device, comprising:
scanning a digital footprint of one or more digital accounts of a user associated with one or more digital platforms;
determining, using an artificial intelligence neural network trained model, a detected event associated with the user has occurred based on the detected event satisfying at least one of a plurality of trigger event conditions;
automatically generating, based on the detected event, an interactive checklist including a plurality of checklist action items to be performed to change information for at least one of the one or more digital accounts of the user based on the detected event;
automatically generating at least one prompt for at least one checklist action item of the plurality of checklist action items on a display for the user to accept or reject the at least one checklist action item;
automatically modifying the interactive checklist with an accept modification responsive to receiving user input for the at least one prompt via the display to accept the at least one checklist action item; and
automatically performing the at least one checklist action item to change information for at least one of the one or more digital accounts of the user based on the detected event and based on the accept modification.

2. The method of claim 1, wherein automatically modifying the interactive checklist further comprises:
displaying the at least one prompt on the display of a user-device that is remote from and communicatively coupled to the computing device.

3. The method of claim 2, further comprising adding a checklist action item to the plurality of checklist action items as part of the interactive checklist based on a response to the at least one prompt.

4. The method of claim 2, further comprising removing the at least one checklist action item responsive to receiving user input for the at least one prompt via the display to reject the at least one checklist action item.

5. The method of claim 1, wherein the detected event comprises a name change of the user, the name change satisfying at least one of the plurality of trigger event conditions such as being verified as a legal name change.

6. The method of claim 1, wherein the detected event comprises an address change of the user, the address change satisfying at least one of the plurality of trigger event conditions such as a notification of the address change via a postal service subscription.

7. The method of claim 1, wherein the detected event comprises one or more of a name change of the user, an address change of the user, a job status of the user, a death of the user, a will preparation for the user, or combinations thereof.

8. The method of claim 1, wherein the detected event comprises a death of the user, the death satisfying at least one of the plurality of trigger event conditions such as being verified as a legally reported death through a death reporting authority.

9. The method of claim 8, wherein the interactive checklist comprises the plurality of checklist action items to be performed by another user in response to the death of the user, the plurality of action items including closure of the one or more digital accounts of the user.

10. A intelligent system for automated digital account change, comprising:
one or more processors;
one or more memory components communicatively coupled to the one or more processors; and
machine readable instructions stored in the one or more memory components that cause the intelligent system to perform at least the following when executed by the one or more processors:
scan a digital footprint of one or more digital accounts of a user associated with one or more digital platforms;
determine, using an artificial intelligence neural network trained model, a detected event associated with the user has occurred based on the detected event satisfying at least one of a plurality of trigger event conditions;
automatically generate, based on the detected event, the interactive checklist including a plurality of checklist action items to be performed to change information for at least one of the one or more digital accounts of the user based on the detected event;
automatically generate at least one prompt for at least one checklist action item of the plurality of checklist action items on a display for the user to accept or reject the at least one checklist action item;
automatically modify the interactive checklist with an accept modification responsive to receiving user input for the at least one prompt via the display to accept the at least one checklist action item; and
automatically perform the at least one checklist action item to change information for at least one of the one or more digital accounts of the user based on the detected event and based on the accept modification.

11. The intelligent system of claim 10, wherein the machine readable instructions causing the intelligent system to automatically modify the interactive checklist when executed by the one or more processors includes:
displaying the at least one prompt on the display of a user-device that is remote from and communicatively coupled to the one or more processors.

12. The intelligent system of claim 11, wherein the machine readable instructions further cause the intelligent system to perform at least the following when executed by the one or more processors:
add a checklist action item to the plurality of checklist action items as part of the interactive checklist based on a response to the at least one prompt.

13. The intelligent system of claim 11, wherein the machine readable instructions further cause the intelligent system to perform at least the following when executed by the one or more processors:
remove the at least one checklist action item responsive to receiving user input for the at least one prompt via the display to reject the at least one checklist action item.

14. The intelligent system of claim 10, wherein the detected event comprises a name change of the user, the name change satisfying at least one of the plurality of trigger event conditions such as being verified as a legal name change.

15. The intelligent system of claim 10, wherein the detected event comprises an address change of the user, the address change satisfying at least one of the plurality of trigger event conditions such as a notification of the address change via a postal service subscription.

16. The intelligent system of claim 10, wherein the detected event comprises one or more of a name change of the user, an address change of the user, a job status of the user, a death of the user, a will preparation for the user, or combinations thereof.

17. The intelligent system of claim 10, wherein the detected event comprises a death of the user, the death satisfying at least one of the plurality of trigger event conditions such as being verified as a legally reported death through a death reporting authority.

18. The intelligent system of claim 17, wherein the interactive checklist comprises the plurality of checklist action items to be performed by another user in response to the death of the user, the plurality of action items including closure of the one or more digital accounts of the user.

19. A intelligent system for automated digital account change, comprising:
one or more processors;
one or more memory components communicatively coupled to the one or more processors; and
machine readable instructions stored in the one or more memory components that cause the intelligent system to perform at least the following when executed by the one or more processors:
scan a digital footprint of one or more digital accounts of a user associated with one or more digital platforms;
determining, using an artificial intelligence neural network trained model, a detected event associated with the user has occurred based on the detected event satisfying at least one of a plurality of trigger event conditions, the detected event comprises a death of the user, the death satisfying at least one of the plurality of trigger event conditions such as being verified as a legally reported death through a death reporting authority;
automatically generate, based on the detected event, the interactive checklist including a plurality of checklist action items to be performed to change information for at least one of the one or more digital accounts of the user based on the detected event;
automatically generate at least one prompt for at least one checklist action item
of the plurality of checklist action items on a display for the user to accept or reject the at least one checklist action item;
automatically modify the interactive checklist with an accept modification responsive to receiving user input for the at least one prompt via the display to accept the at least one checklist action item, the modifying including displaying the at least one prompt on the display of a user-device that is remote from and communicatively coupled to the one or more processors; and
automatically perform the at least one checklist action item to change information for at least one of the one or more digital accounts of the user based on the detected event and based on the accept modification.

20. The intelligent system of claim 19, wherein the machine readable instructions causing the intelligent system to automatically modify the interactive checklist when executed by the one or more processors includes:
displaying the at least one prompt on the display of the user-device that is remote from and communicatively coupled to the one or more processor.
